(19) United States
(12) Patent Application Publication
(10) Pub. No.: US 2015/0328642 A1
(43) Pub. Date: Nov. 19, 2015

(54) SHREDDING DEVICE AND METHOD FOR SHREDDING PHYSICAL MEDIA USING HOUSEHOLD ELECTRIC POWER

(71) Applicant: Electronic Recyclers International, Inc., Fresno, CA (US)

(72) Inventors: John S. Shegerian, Fresno, CA (US); Anthony Borges, Fresno, CA (US); John Reick, Fresno, CA (US)

(73) Assignee: Electronic Recyclers International, Inc., Fresno, CA (US)

(21) Appl. No.: 14/281,839

(22) Filed: May 19, 2014

(51) Int. Cl. B02C 18/00; B02C 18/16

(52) U.S. Cl. CPC B02C 18/0007; B02C 18/16; B02C 2018/0015; B02C 2018/0023; B02C 2018/0046; B02C 2018/168

(57) ABSTRACT

A shredding device and method for shredding physical media using household electric power are disclosed. The physical media may include data storage device or medium configured to store information. The shredding device may be configured to facilitate the destruction of the physical media to a final strip size no more than ¾ inches wide. The shredding of the physical media may be enabled by a motor which may be energized by power drawn from a regular wall outlet in a building. In some implementations, the shredding mechanism may comprise rotor members configured to rotate in opposite directions. A sound enclosure may be used to attenuate the sound produced by during the shredding of the physical media. In some implementations, the sound attenuation is achieved through lining fiber wools around the interior surfaces of the sound attenuation enclosure.

### FIELD OF THE DISCLOSURE

This disclosure relates to shredding physical media in a non-industrial environment.

### BACKGROUND

Shredding of physical media such as data storage device (e.g., hard disk drive), plastic films, compact discs (CD), digital video discs (DVD), blue ray discs, SD cards, USB flash drives and/or any other physical media are conventionally done at an industrial site. For example, users may be required to ship physical media to a recycling facility that is equipped with shredders designed to shred the physical media. These shredders, however, may not be used in a non-industrial environment, such as an office, a store, a household, a lab or any other type(s) of non-industrial environment for a number of reasons. One of the reasons is that the size of these shredders simply does not fit in such an environment. Another reason is that the power needed to operate the shredders cannot be simply drawn from a wall outlet in such an environment. Still another reason is that the noise produced by these shredders during the shredding of the physical media is simply not suitable for such an environment. Yet another reason is that these shredders are typically designed for producing high throughput, which may not be necessary and economically viable for entities that do not shred physical media on a large scale.

### SUMMARY

One or more aspects of the disclosure relate to a shredding device configured to facilitate destruction of physical media in a non-industrial environment using household electric power. The shredding device may be continently mounted on a table, a wheel cart, a stand, and/or any other type(s) of base(s) that may fit in a regular room in a building. The shredding device may provide a solution for an entity, such as a company, a person or any other type(s) of entity, to destroy physical media on-site without having to ship the physical media an off-site such as a recycling facility. This may present an affordable option to the entity to conveniently prevent information stored on unwanted physical media from being compromised. In some examples, this device may be used by commercial operators to offer customer destruction of their physical media in a store.

As such, the shredding device may be configured to meet the requirements for highly secure data destruction on-site such as in an office, a hospital, a store, a lab, a household, or any other type(s) of non-industrial environment. It is noted that the shredding device may be configured to be compliant with one or more laws governing physical media destruction. For example, the shredding device may be configured to be compliant with Federal data destruction laws such as the Health Insurance Portability and Accountability Act (HIPPA), Gramm-Leach Bliley (GLB), the Sarbanes-Oxley Act (SOX), the Fair and Accurate Credit Transactions Act (FACTA), the Fair Credit Reporting Act, and Department of Defense Standards, and/or other restrictions and/or laws.

The shredding device in accordance with the disclosure may include a shredding assembly, an electronically powered motor, a power unit, a processor, a sound attenuation enclosure, and/or other components.

The shredding assembly may have a material inlet and a material outlet. The material inlet may be arranged to introduce physical media to be destructed into the shredding assembly. The shredding may produce particles of the physical media having a final size no more than ¾ inches wide. The shredding assembly may be configured to produce particles of physical media through cutting, crushing, tearing, shredding and/or other process and/or processes suitable for the intended purpose(s) presented herein. In some implementations, the shredding assembly may comprise a first rotor having cutters rigidly mounted thereon and a second rotor having cutters rigidly mounted thereon. In those implementations, the first rotor may be arranged in parallel to the second rotor to form interleaved intersections to facilitate shredding of the physical media. The first and second rotors may rotate in opposite directions and, in some implementations, at different speeds to grip the physical media dropped onto the intersections and to shred the physical media.

The electronically powered motor may be configured to enable the shredding assembly to shred the physical media. In some implementations, the electronically powered motor may enable the shredding assembly through a gear arrangement operatively coupled to the shredding assembly. In some implementations, the electronically powered motor may include a 120-volt electric motor.

The power unit may be configured to provide power to the electronically powered motor and any other components of the shredding device. In some implementations, the power unit may draw the power provided to the electronically powered motor from a wall outlet in a building. In some implementations, the wall outlet may include a 120-volt AC outlet.

The sound attenuation enclosure may comprise one or more side walls defining an interior volume. At least one of the sidewalls may include an opening that extends from an exterior of the sound attenuation enclosure to the interior volume. The sound attenuation enclosure may be configured to house the shredding assembly within the interior volume such that the material chute of the shredding assembly may be positioned adjacent to the opening. The interior volume of the sound attenuation enclosure may be configured to attenuate sound produced by the shredding assembly during shredding of the physical media. In some implementations, one or more side walls of the sound attenuation enclosure may be lined with ceramic wool for achieving sound attenuation. In some implementation, a user interface panel may be arranged on the exterior of the sound attenuation enclosure. The user interface panel may comprise a power switch, a speed control, an emergency stop control, a start control, a reverse control, a regular stop control, a display, and/or any other controls for controlling and/or monitoring various aspects of the operation of the shredding device.

In some implementations, at least one of the side walls of the sound attenuation enclosure may be configured to be partially or completely removed from the enclosure such that an access to the shredding assembly may be facilitated. Such an access may facilitate maintenance of the shredding device, for example, to address a jam. In some implementations, the sound attenuation enclosure may comprise a safety mechanism to ensure the shredding assembly does not operate while the removable side wall(s) is removed from the enclosure.

The processor may be configured by machine-readable instruction to control various aspects of the operation of the shredding device. In some implementations, one or more user interfaces may be electronically facilitated by the processor. In some implementations, a unit counter may be implemented by the processor to keep track of a quantity of the physical media that has passed through material inlet of the shredding assembly.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates one example of a shredding device for destructing physical media in accordance with the disclosure.

FIG. 2A illustrates a view of the sound attenuation enclosure shown in FIG. 1.

FIG. 2B illustrates another view of the sound attenuation enclosure shown in FIG. 1.

FIG. 3 illustrates an exploded view of the shredding assembly shown in FIG. 1.

FIG. 4 illustrates a side perspective view of the shredding assembly shown in FIG. 1.

FIG.5 illustrates a front view of the shredding assembly shown in FIG.1.

FIG. 6 illustrates a top view of the shredding assembly shown in FIG. 1.

FIG. 7 illustrates another side view of the shredding assembly shown in FIG. 1.

FIG. 8 illustrates a sectional view of the shredding assembly along sight line C-C shown in FIG. 5.

FIG. 9 illustrates a sectional view of the shredding assembly along sight line B-B shown in FIG. 7.

FIG. 10 illustrates a sectional view of the shredding assembly along sight line A-A shown in FIG. 7.

FIG. 11 illustrates an exemplary method for shredding physical media using household electric power in accordance with the disclosure.

### DETAILED DESCRIPTION

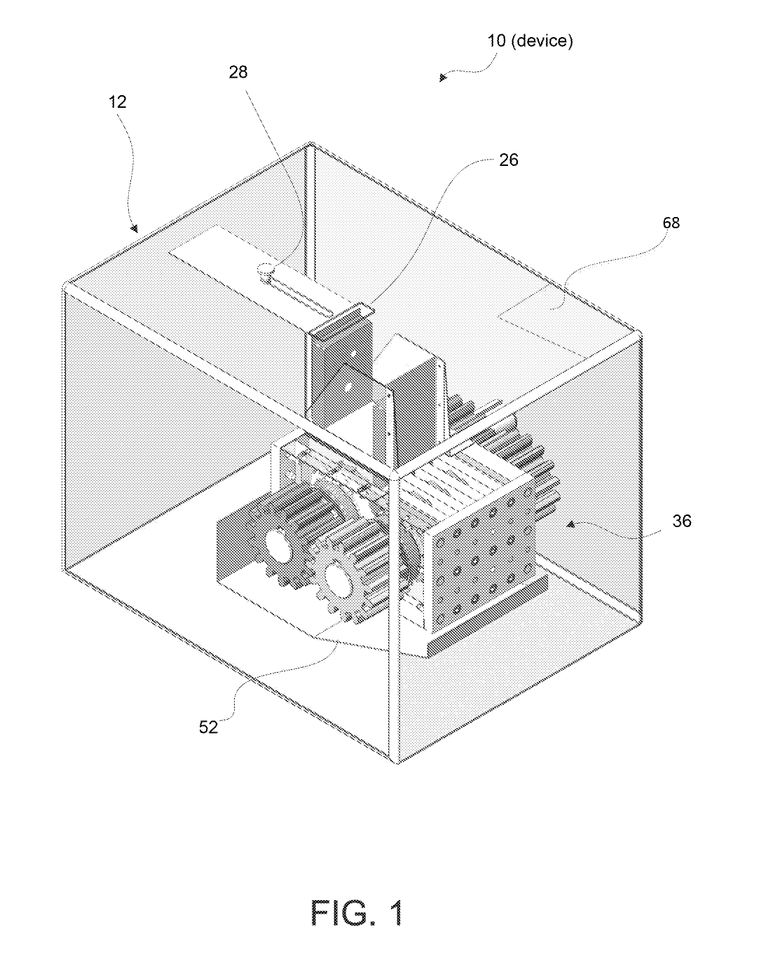

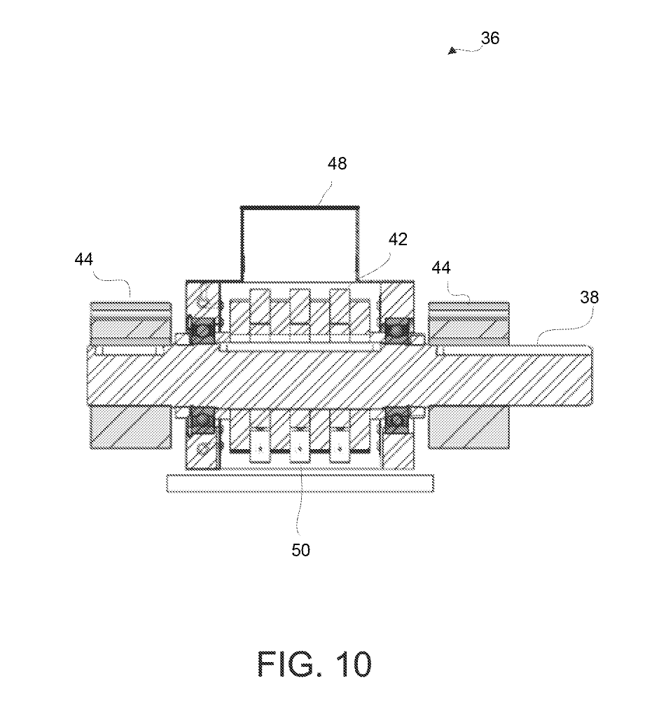

With continuous reference to FIGS. 1-10, the shredding device in accordance with the disclosure will be described. FIG. 1 illustrates one example of a shredding device 10 configured to facilitate destruction of physical media in accordance with one or more implementations. The destruction facilitated by the shredding device 10 may shred the physical media to a final particle size that ensures complete destruction of the physical media such that any electronic information stored by the physical media is unrecoverable. The shredding device 10 may be configured to process physical media for destruction that includes, without limitation, electronic storage devices such as a computer hard drive, a processor, a laptop, a desktop computer, a cell phone, a smart phone, an external hard drive, optically readable storage media (e.g., CDs, DVDs, Blue Ray discs, etc.), magnetically readable storage media (e.g., magnetic tape, magnetic hard drive, a magnetic stripe card, floppy drive, etc.), electrical charge-based storage media (e.g., EEPROM, RAM, etc.), solid-state storage media (e.g., flash drive, etc.), and/or other physical media that electronically stores information. The shredding device 10 may be configured to produce particles of physical media through cutting, crushing, tearing, shredding and/or other process and/or processes suitable for the intended purpose(s) presented herein. In some implementations, the shredding device 10 may be configured to be mounted to a base (not depicted in FIG. 1). The base may include a table top, a wheeled cart, a stand, and/or any other type(s) of base(s). In one implementation, without limitation, the size of the shredding device 10 is approximately 18″ (W)×28″ (H)×24″ (D) and the weight of the shredding device 10 is about 200 pounds.

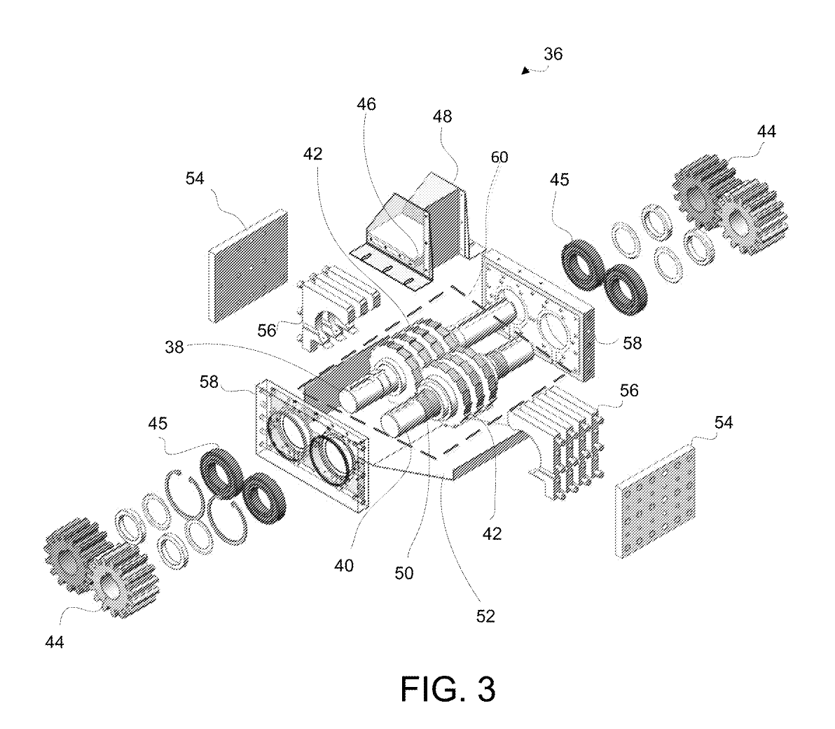

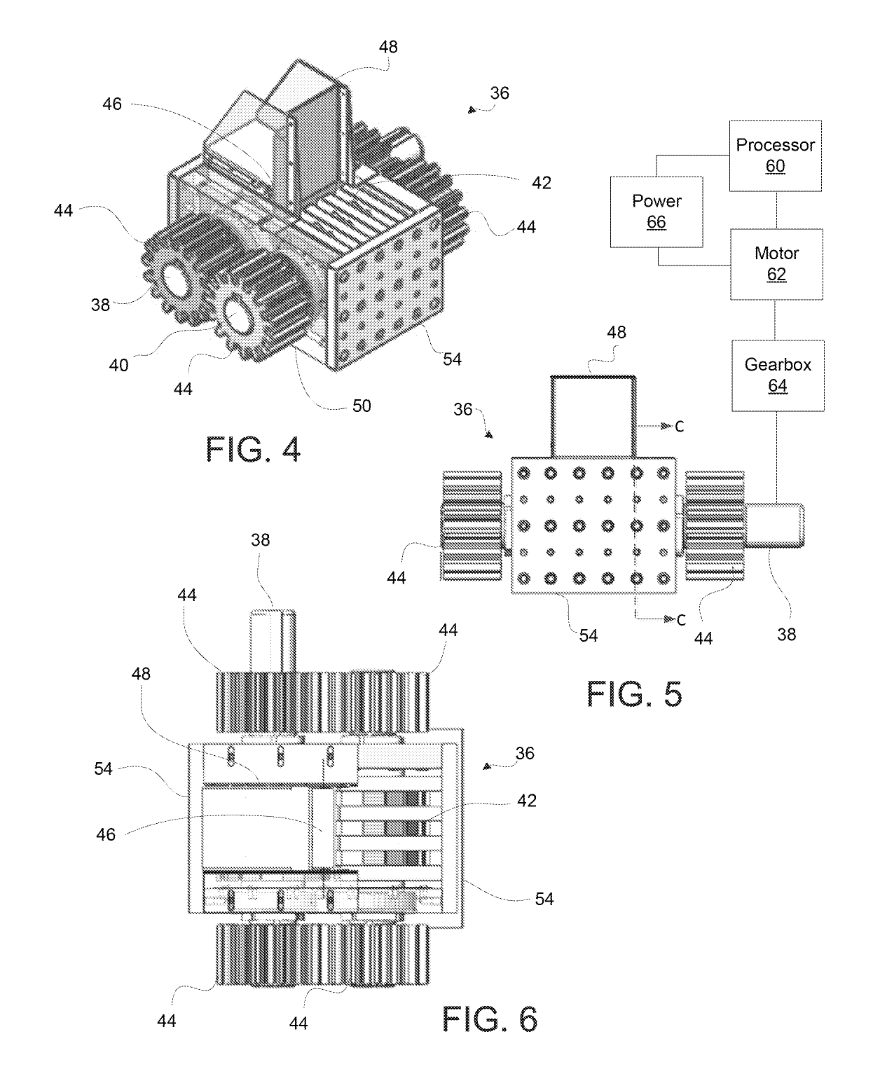

As shown in this example, the shredding device 10 may include a sound attenuation enclosure 12, a shredding assembly 36, an electronically powered motor 62 (FIG. 5), a power unit 66 (FIG. 5), and/or other components. The shredding assembly 36 may be configured to facilitate shredding of the physical media that is introduced into shredding assembly 36. The shredding assembly 36 may have a material inlet and a material outlet (see, e.g., FIGS. 3 and 4). The shredding performed by shredding assembly 36 may produce particles of the physical media. The particles may comprise, for example, broken pieces of the physical media. The produced particles of the physical media may have a final size. In some implementations, the final size of the particles of the physical media may correspond being less than 19.05 millimeters (¾ inches) wide by various length. The particles may be discharged from the material outlet of shredding assembly 36 to the region below. FIGS. 3-10 illustrate various views of the shredding assembly 36. The shredding assembly 36 will be described in detail with reference to FIGS. 3-10.

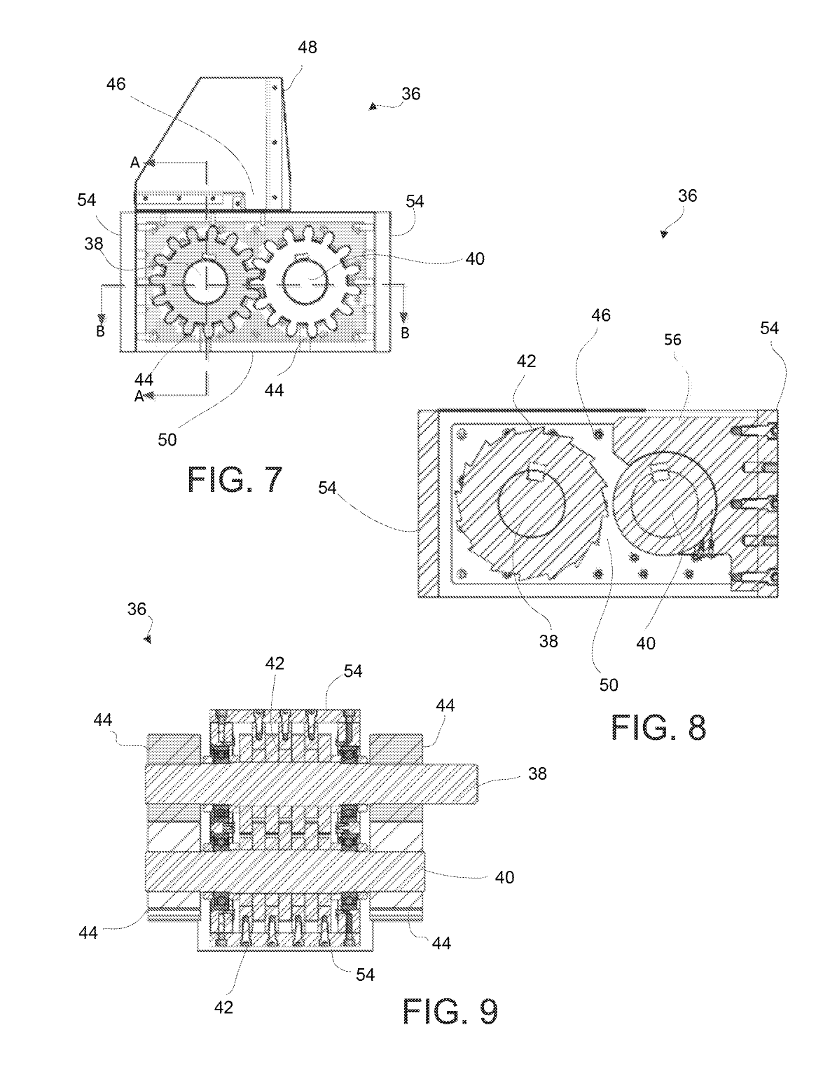

As shown in FIG. 3, the shredding assembly 36 may include a material chute 48, a material inlet 46, a shredding mechanism 60, bearings 45, transfer gears 44, mounting plates 54, cleaning sections 56 and/or any other components. As can be seen from FIG. 7, the material chute 48 has side and bottom panels by way of which the physical media to be destructed may be deposited and directed into shredding mechanism 60 through material inlet 46. In some implementations, the material inlet 46 may be configured such that no more than a number of media (e.g., only one hard disk) may pass through the material inlet at a time.

In this example, the shredding mechanism 60 comprises two rotors 38 and 40 with cutters/blades 42 rigidly mounted thereon. It should be understood the shredding mechanism 60 included in the shredding assembly 36 in accordance with the disclosure may not necessarily be limited to rotary shredding. For example, in another implementation, the shredding mechanism 60 may include a hammer mill, a jet mill, or any other non-rotary shredding means.

As shown in FIG. 3, the rotors 38 and 40 (e.g., shredding shafts) may be arranged horizontally in parallel to each other along the elongated axis running through the rotors 38 and 40. In this example, rotor 38 is the first rotor and rotor 40 is the second rotor of the shredding assembly 36. The two rotors may be actuated to rotate in opposite directions. As shown, rotor 38 in this example has 4 cutters 42 rigidly mounted thereon and rotor 40 in this example has 3 cutters 42 rigidly mounted thereon. As shown, the shape of the cutters 42 may be rectangular for shredding the physical media into strips having sizes in accordance with the disclosure. However, this is not intended to be limiting. In various implementations, the shape of the cutters 42 may vary as however desired. In some implementations, the cutters 42 on the rotor 38 may have a shape different from that of those on rotor 40. As shown, the center distance of two rotors 38 and 40 may be arranged such that the cutters 42 on rotor 38 may intersect with cutters 42 on rotor 40 in an interleaving manner (e.g., see FIG. 9). During operation, the physical media introduced through the material inlet 46 may drop on to cutter intersections due to gravity; and the opposite movement of rotors 38 and 40 may grip the dropped physical media and cause the physical media to be sheared. In some implementations, rotors 38 and 40 may rotate at different speeds.

It should be understood although a two rotor shredding mechanism 60 is illustrated in this example, this is not intended to be limiting. In some other examples, the shredding mechanism 60 may comprise however many rotary members to facilitate shredding of the physical media in accordance with the disclosure. It should be noted that the shredding of the physical media in accordance with the disclosure may be such that it is based on processing flow rate, material volume and/or weight, speed, shaft speed, and/or other parameter. In one implementation, without limitation, the throughput of the shredding mechanism 60 employed in that implementation is about one hard disk driver per minute. In another implementation, the shredding mechanism employed in that implementation may be configured to process up to 60 lbs of physical media per hour.

Also shown in FIG. 3 are cleaning sections 56 that may be included in the shredding assembly 36. As shown in FIG. 4, the cleaning section 56 may have cleaning fingers that may be mounted between cutters 42 on the rotors 38 and 40. As shown in FIG. 8, the cleaning sections 56 may be mounted to the rotors 38 and 40 by surrounding the circumference of the rotors 38 and 40. In this way, the cleaning sections 56 may deflect the shredded material downwards and cause the shredded material to be discharged from the cutters 42 through the material outlet 50. This may prevent shredded material from being trapped between successive cutters of the same rotor 38 or 40 and forming a layer of compact, which may cause stress between the rotors 38 and 40. In some implementations, the cleaning sections 56 may comprise non-ferromagnetic material such as non-magnetic stainless steel to prevent accumulation of magnets. As can be seen from FIGS. 4 and 8, the other end of the cleaning sections 56 may be mounted to corresponding mount plates 54 for stabilization.

The transfer gears 44 may be configured to distribute torque to one or both of the rotors 38 and 40. As can be seen in FIG. 3, in this example, the transfer gears 44 may be operatively connected to the rotors 38 and 40 through a series of bearings and spacers 45 via the rotor guides 58. As illustrated in FIG. 5, in some implementations, a gearbox 64 may be arranged between the motor 62 and the rotor 38. The gearbox 64 may be configured to transfer torque provided by motor 62 to the rotor 38, which may transfer the torque provided by the motor to rotor 40 through the transfer gears 44.

The shredded material collection bin 52 may be arranged in a region below the rotors 38 and 40 as shown. The bin 52 may be used to collect particles of the physical media discharged from the material outlet 50. The bin 52 may be configured such that it may be removed from the sound attenuation enclosure 12 for extracting shredded material.

The electronically powered motor 62 may be configured to convert power provided by the power unit 66 to torque and to provide the torque to the shredding assembly 36 to facilitate the counter-rotation of rotors 38 and 40 as described herein. As shown in FIG. 5, in some implementations, the motor 62 may be connected to the rotor(s) of the shredding assembly 36 via gearbox 64. As also can be seen from FIG. 5, the motor 62 may be connected to power unit 66 and may energized by the power unit 66 to set the shredding assembly in motion described herein. In some implementations, the voltage requirement to energize the motor 62 may be between 120 volts to 240 volts. In some implementations, the energization of motor 62 may be controlled by the processor 60.

Power unit 66 may be configured to draw power from a power source and provide the power to the motor 62, the processor 60, and/or any other components of the shredding device 10. The power source from which the power unit 66 may draw power may include an AC power supply in a building, which may provide regular household electricity between 120 volts and 240 volts. The power unit 66 may be configured to connect to (e.g., plug into) a wall outlet to draw power from the power source.

The processor 60 may be configured by machine-readable instructions to control various aspects of the operation of the shredding device 10. In some implementations, the processor 60 may be configured to start, stop, change preset speed of, change rotation direction of, and/or any other controllable aspects of the motor 62. In some implementations, the processor 60 may be configured to implement various alarm conditions with respect to the shredding device 10. For example, the processor 60 may be configured to generate an alarm when a jam is detected, when the temperature of the motor 62 is over a preset temperature limit, and/or when any other alarm conditions occur. In some implementations, the processor 60 may be configured to implement an overload protection procedure to stop the shredding assembly 36 when a jam is detected. In some implementations, the processor 60 may be configured to facilitate implementation of a unit counter for keeping track of a quantity of physical media that has passed through the material inlet 46.

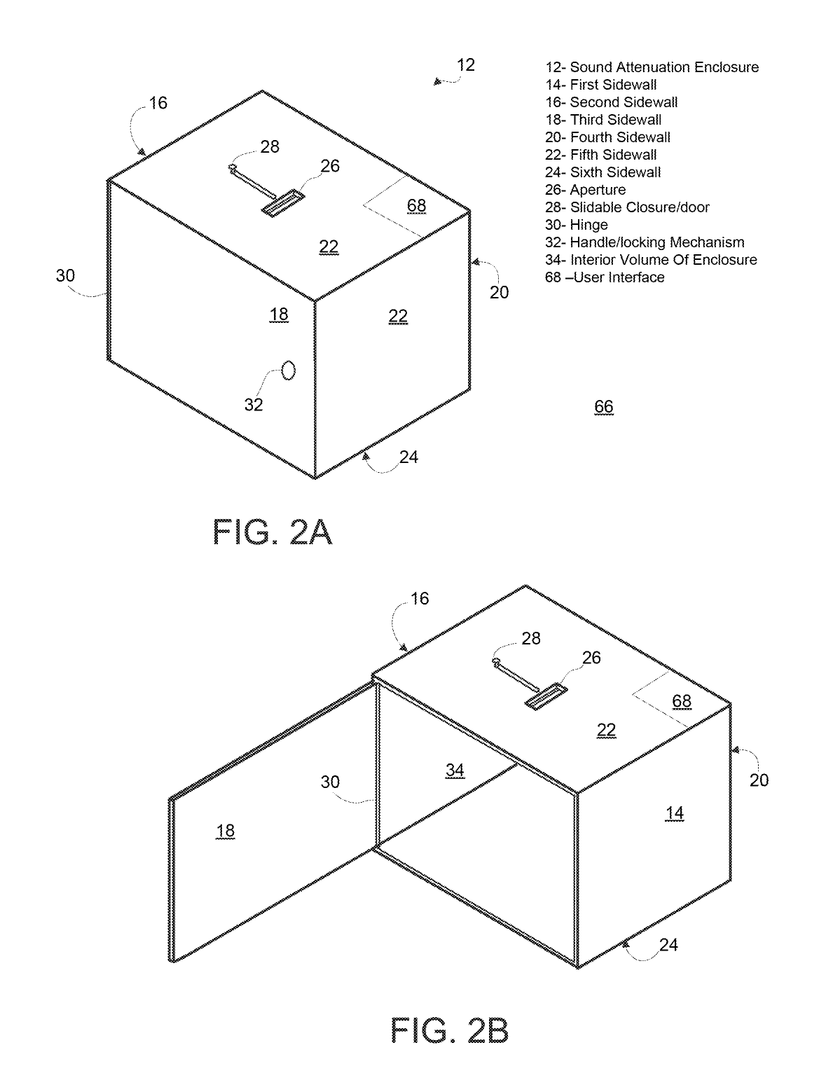

The sound attenuation enclosure 12 may be configured to house the shredding assembly 36, the motor 62, the power unit 66, the processor 60, the gearbox 64 and/or other components of the shredding device 10. The sound attenuation enclosure 12 may be configured to attenuate the sound produced during the shredding of the physical media. The sound attenuation enclosure 12 may be a rigid structure. The sound attenuation enclosure 12 may have an interior volume defined by one or more sidewalls. The sound attenuation enclosure 12 may include at least one sidewall that comprises an operable door that facilitates operator entrance into the interior volume of sound attenuation enclosure 12. FIGS. 2A-B illustrate two perspective views of the sound attenuation enclosure 12 shown in FIG. 1. The sound attenuation enclosure 12 will be described in detail with reference to FIGS. 2A-B.

As can be seen from FIGS. 2A-B, the sound attenuation enclosure 12 may be a six-sided structure. As shown, the sound attenuation enclosure 12 may have a first sidewall 14, a second sidewall 16, a third sidewall 18, a fourth sidewall 20, a fifth sidewall 22, and a sixth sidewall 24. In this example, the third sidewall 18 may be partially removed from the sound enclosure 16 via a hinge 30 to serve as a door. As shown, the third sidewall 18 may include a handle/locking mechanism 32 to facilitate opening the third sidewall 18, as well as keyed access to the shredding device 10. FIG. 2B illustrates a view of the sound enclosure 12 when the third sidewall 18 is opened. In some implementations, a safety mechanism (not depicted in this example) may be included in the shredding device 10 such that the shredding device 10 may be powered only when the sound attenuation enclosure 16 is in a closed state as shown in FIG. 2A. In one implementation, without limitation, the safety mechanism includes a safety switch disposed adjacent to hinge 30. In that implementation, the safety switch may be activated when the sound attenuation enclosure 12 is in an open state as shown in FIG. 2B to prevent the shredding assembly 36 from being powered. This may be achieved by shutting off the motor 62, sending a control command to the processor 60 instructing the processor 60 not to start the motor 62 until instructed otherwise, and/or any other methods. The safety switch may be deactivated when the sound attenuation enclosure is in a closed state shown in FIG. 2A. The deactivation of the safety switch may allow the shredding assembly 36 to be enabled by the motor 62. In some implementations, the deactivation of the safety switch may be further based on whether the door (e.g., the third sidewall 18 in this example) of the sound enclosure 12 is securely locked, for example by the handle/locking mechanism 32.

As also shown in FIGS. 2A-B, the top of the sound attenuation enclosure 12—the fifth sidewall 22 in this example—may include an aperture 26, a slidable closure for the aperture 26, a base 68 available for mounting a user interface panel, and/or any other elements. The aperture 26 may serve an opening extending into the interior volume of the sound attenuation enclosure 12. The aperture 26 may be arranged so as to allow the material chute 48 of the shredding assembly 36 to be positioned adjacent to the aperture 26. Through the aperture 26, physical media to be destructed may be fed into the material chute 48. The slidable closure 28 may be in an open position and a closed position with respect to the aperture 26. The slidable closure 28 may be slid to from the open position to the closed position, or vice versa, to close or open the aperture 26. In some implementations, the shredding assembly 36 may be configured such that it may not operate when the aperture 26 is not closed by the slidable closure 28.

The base 68 may be configured to mount a user interface panel for controlling various aspects of the shredding device 10. In some implementations, the user interface panel may comprise a power switch, a speed control, an emergency stop control, a start control, a reverse control, a regular stop control, a display, and/or any other controls. The power switch may allow an operator to turn the power on or off for the shredding device 10. The start control may allow the operator to start the operation of the shredding assembly 36. The speed control may allow the operator to switch between preset speeds of the shredding assembly 36. The reverse control may allow the user to change rotation direction of the rotors of the shredding assembly 36. The emergency stop control may allow the operator to stop the operation of the shredding assembly 36 immediately, for example, in a situation where one or more alarms are observed. The regular stop control may allow the operator to stop the operation of shredding assembly normally (e.g. to execute normal stop procedure of the shredding device 10) when the shredding of the physical media is observed to have been completed. In some implementations, some or all of the control actions initiated by an operator via the user interface panel may be transmitted to processor 60 for processing. In those implementations, responsive to the control actions from the operator, the processor 60 may generate control commands to control various aspects of the shredding device 10 in accordance with the control actions.

In some implementations, the controls on the user interface panel provided to the operator may be in the forms of physical buttons, switches, dials, knobs and/or any other type(s) of physical control(s). In some implementations, the controls on the user interface panel may be provided to the operator via a touch sensitive surface such as a touch screen or any other type of touch sensitive surface.

In some implementations, the user interface panel may comprise a display for displaying information regarding the shredding device 10. In one implementation, without limitation, the display may include a LED screen. The information displayed may be provided by the processor 60. Examples of the information that may be displayed on the user interface panel may include a unit counter indicating a quantity of physical media that has passed through the material inlet 46 since the last reset, one or more alarms alerting the operator of various preset alarm conditions in the shredding device 10 (e.g., jam, overheat, overload, overstress, door open, and/or any other alarm conditions), status of the shredding (e.g., a speed of the rotor(s), a temperature of the motor 62, sound level produced, and/or any other status information), and/or any other type of information.

The sound enclosure 12 may be configured to attenuate sound produced during the shredding of the physical media by the shredding assembly 36. The sound produced during the shredding of the physical media may be attenuated by the sound attenuation enclosure 12 to 65-85 decibels. In some implementations, the sound produced by the shredding device 10 is no more than 75 decibels. This may be achieved in a number of ways. For example, in one implementation, sound blanks may be placed over motor 62 and shredding assembly 36 to reduce the sound produced by the motor 62 and shredding assembly 36, respectively. In another implementation, fiber wool such as ceramic wool may be lined on the interior surface of the sidewalls of the sound attenuation enclosure 12 to absorb the sound. Other similar methods such as installing acoustic foams, panels with sound-retarding material, and/or any other sound reduction components within the interior volume 34 of the sound enclosure 12 are contemplated.

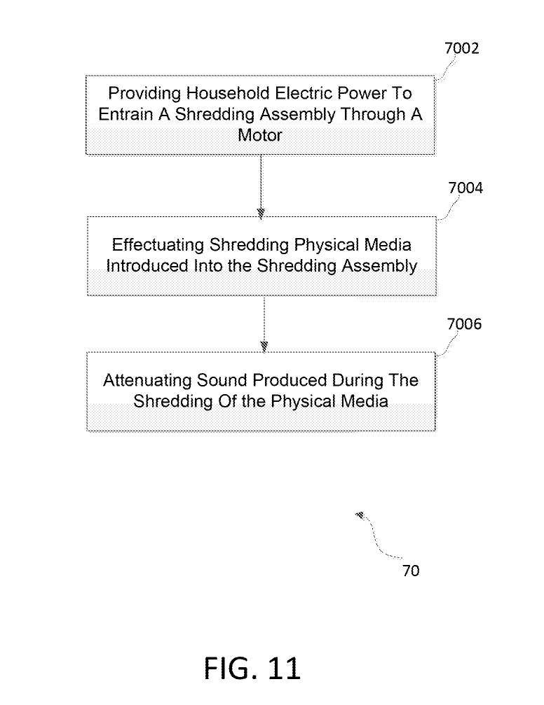

FIG. 11 illustrates an exemplary method 70 for shredding physical media using household electric power in accordance with the disclosure. The operations of method 70 presented below are intended to be illustrative. In some implementations, method 70 may be accomplished with one or more additional operations not described, and/or without one or more of the operations discussed. Additionally, the order in which the operations of method 70 are illustrated in FIG. 11 and described below are not intended to be limiting.

In some implementations, method 70 may be implemented using a shredding device. The shredding device may include a shredding assembly, an electronically powered motor, a sound attenuation enclosure, and/or other components. For example, method 70 may be implemented using shredding device 10 (shown in FIGS. 1-10 and described herein).

Referring now to method 70 in FIG. 11, at an operation 7002, household electric power may be provided to the electronically powered motor to enable the shredding assembly. In some implementations, at least some of the power that is provided may be drawn from a wall outlet in a building. In some implementations, the motor included in the shredding device is a 120V electric motor. In some implementations, operation 7002 may be performed by a power unit and/or a processor the same or similar as the power unit 66 and processor 60 (shown in FIG. 5 and described herein).

At an operation 7004, shredding of the physical media may be effectuated through the shredding assembly. The shredding assembly may have a material inlet and a material outlet. The material inlet may be arranged to introduce physical media to be destructed into the shredding assembly. The shredding may produce strips of the physical media having a final size no more ¾ inches wide by various length. The shredding assembly may be configured to produce particles of physical media through cutting, crushing, tearing, shredding and/or other process and/or processes suitable for the intended purpose(s) presented herein. In some implementations, the shredding assembly may comprise a first rotor having cutters rigidly mounted thereon and a second rotor having cutters rigidly mounted thereon. In those implementations, the first rotor may be arranged in parallel to the second rotor to form interleaved intersections that facilitate shredding of the physical media. The first and second rotors may rotate in opposite directions and, in some implementations, at different speeds to grip the physical media dropped onto the intersections and to shred the physical media. In some implementations, operation 7004 may be performed using a shredding assembly included in a shredding device the same as or similar to shredding assembly 36 (shown in FIGS. 3-10 and described herein). In some implementations, effectuating the shredding of the physical media in operation 7004 may involve a processor similar to or same as the processor 60 (shown in FIG. 5 and described herein).

At an operation 7006, sound produced during the shredding of the physical media may be attenuated through a sound attenuation enclosure. The sound attenuation enclosure may be a rigid structure. The sound attenuation enclosure may have an interior volume defined by one or more sidewalls. The sound produced during the shredding of the physical media may be attenuated by using a sound attenuation enclosure to 65-85 decibels. This may be achieved in a number of ways. For example, in one implementation, sound blanks may be placed over motor and shredding assembly to reduce the sound produced by the motor and shredding assembly, respectively. In another implementation, fiber wool such as ceramic wool may be lined on the interior surface of the sidewalls of the sound attenuation enclosure to absorb the sound. Other similar methods such as installing acoustic foams, panels with sound-retarding material, and/or any other sound reduction components within the interior volume of the sound enclosure are contemplated. In some implementations, operation 7006 may be performed using a sound attenuation enclosure the same as or similar to sound attenuation enclosure 12 (shown in FIGS. 2A-B and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A shredding device configured to facilitate destruction of physical media using household electric power, the shredding device comprising:
a shredding assembly having a material inlet and a material outlet, the shredding assembly being configured to produce particles by shredding physical media that is introduced into the shredding assembly through the material inlet and discharge the produced particles from the material outlet, wherein any given one of the-strips produced by the shredding assembly has a final size no more than ¾ inches wide;
an electronically powered motor operatively connected to the shredding assembly via a gearbox, the gearbox being configured to provide torque, enabling the shredding assembly to shred the physical media introduced through the material inlet;
a power unit configured to provide power to the electronically powered motor, the power provided to the motor being drawn from a wall outlet in a building; and
a sound attenuation enclosure, the sound attenuation enclosure comprising one or more sidewalls defining an interior volume, wherein at least one sidewall includes an opening that extends from an exterior of the sound attenuation enclosure to the interior volume, the sound attenuation enclosure being configured to contain the shredding assembly within the interior volume such that the material inlet of the shredding assembly is positioned adjacent to the opening, wherein the interior volume of the sound attenuation enclosure is configured to attenuate sound produced by the shredding assembly during shredding of the physical media.

2. The shredding device of claim 1, additionally comprising:
one or more physical processors configured by computer-readable instructions to control the operation of the shredding device.

3. The shredding device of claim 2, additionally comprising a user interface configured to receive user entry and/or selection of control commands for controlling the shredding device using the one or more processors.

4. The shredding device of claim 1, further comprising a shredded material collection container contained within the interior volume of the sound attenuation enclosure, the shredded material collection container being arranged in a region below the material outlet of the shredding assembly, the shredded material collection container being configured to receive the shredded physical media that is communicated through the material outlet.

5. The shredding device of claim 4, wherein the shredded material collection container is removable from the shredding device.

6. The shredding device of claim 1, wherein the shredding assembly comprises a rotary shredding mechanism.

7. The shredding device of claim 6, where in the rotary shredding mechanism comprises a first rotor and a second rotor, wherein the first rotor is arranged, horizontally, parallel to the second rotor, the first and second rotors each having multiple cutters rigidly mounted thereon such that the cutters on the first rotor and second rotor form interleaved intersections facilitating the shredding of the physical media.

8. The shredding device of claim 7, wherein the rotary mechanism further comprises a gearbox operatively connected to one end of the first rotor, the gearbox being configured to receive torque from the motor and transfer the torque to the first rotor to actuate the first rotor.

9. The shredding device of claim 8, wherein the first and second rotors further comprise transfer gears mounted thereon, wherein the first rotor transfers the torque received from the gearbox to the second rotor to actuate the second rotor.

10. The shredding device of claim 7, wherein the first rotor comprises four cutters and the second rotor comprises three cutters.

11. The shredding device of claim 1, wherein the sound attenuation enclosure is configured such that at least one sidewall of the sound attenuation enclosure is partially or completely removable from the sound attenuation enclosure.

12. The shredding device of claim 11, further comprising a safety switch disposed adjacent to the at least one sidewall, the safety switch having an activated mode and a deactivated mode, the safety switch being configured such that the safety switch is set to the activated mode when the at least one side wall is removed from the sound attenuation enclosure and is set to the deactivated mode when the at least side wall is attached to the sound attenuation enclosure, wherein during the deactivated mode of the safety switch, the operation of the shredding device is facilitated, and during the activated mode of the safety switch, the operation of the shredding device is prevented.

13. The shredding device of claim 1, wherein the electronic power motor is a 120 volt electric motor.

14. The shredding device of claim 1, wherein the sound attenuation enclosure is configured such that sound that is produced by the shredder during the shredding of the physical media is attenuated to 65-85 decibels.

15. The shredding device of claim 1, wherein the sound attenuation enclosure is configured such that sound that is produced by the shredder during the shredding of the physical media is attenuated to no more than 75 decibels.

16. The shredding device of claim 1, wherein the one or more sidewalls of the sound attenuation enclosure comprise fiber wool.

17. The shredding device of claim 16 wherein the fiber wool is ceramic wool.

18. A method for facilitating destruction of physical media using household electric power, the method being implemented in a shredding device including a shredding assembly, an electronically powered motor, and a sound attenuation enclosure, wherein
the shredding assembly has a material inlet and a material outlet,
the motor is operatively connected to the shredding assembly, and
the sound attenuation enclosure comprises one or more sidewalls defining an interior volume, wherein at least one sidewall includes an opening that extends form an exterior of the sound attenuation enclosure to the interior volume, the sound attenuation enclosure being configured to contain the shredding assembly within the interior volume such that the material inlet of the shredding assembly is positioned adjacent to the opening, the method comprising:
providing power to the electronically powered motor to enable the shredding assembly, the power provided to the motor being drawn from a wall outlet in a building;
effectuating shredding of physical media that is introduced into the shredding assembly through the material inlet via the opening on the sound attenuation enclosure, the produced particles being discharged through the material outlet, wherein any given one of the particles produced by the shredding assembly has a final size no more than ¾ inches long; and
attenuating sound produced by the shredding assembly during shredding of the physical media through the sound attenuation enclosure.

19. The method of claim 19, wherein the shredding assembly comprises a first rotor and a second rotor, wherein the first rotor is arranged horizontally, parallel to the second rotor, the first and second rotors each having multiple cutters rigidly mounted thereon such that the cutters on the first rotor and second rotor form interleaved intersections, and wherein the shredding of the physical media is facilitated by the interleaved intersections.

20. The method of claim 19, wherein attenuating sound produced by the shredding assembly through the sound attenuation enclosure includes lining the one or more sidewalls of the sound attenuation enclosure with fiber wool.
